(19) United States
(12) Patent Application Publication
(10) Pub. No.: US 2023/0289051 A1
(43) Pub. Date: Sep. 14, 2023

(54) INTERACTING METHOD AND APPARATUS, DEVICE AND MEDIUM

(71) Applicant: BEIJING BYTEDANCE NETWORK TECHNOLOGY CO., LTD., BEIJING (CN)

(72) Inventors: Liping LI, BEIJING (CN); Qian JIANG, BEIJING (CN)

(21) Appl. No.: 18/004,842

(22) PCT Filed: Jul. 6, 2021
(86) PCT No.: PCT/CN2021/104681

§ 371 Date: Jan. 9, 2023

(30) Foreign Application Priority Data
Jul. 9, 2020 (CN) 202010656148.6

(51) Int. Cl. G06F 3/0488; G06F 9/451; G06F 3/0486; G06F 40/169; G06F 3/0481

(52) U.S. Cl. CPC G06F 3/0488; G06F 3/0481; G06F 3/0486; G06F 9/451; G06F 40/169

(57) ABSTRACT

Provided are an interacting method and apparatus, an electronic device, and a storage medium. The method includes: in response to a triggering instruction in a first direction for first content on a page, displaying (110) the triggered first content and a triggered first triggering control; triggering (120) a first interacting operation on the first content based on a position of the first triggering control in a corresponding region of the first content. The interacting operation is simplified and the interacting efficiency is improved.

### CROSS-REFERENCE TO RELATED APPLICATIONS

This application claims priority to Chinese patent application No. 202010656148.6 titled “INTERACTING METHOD AND APPARATUS, DEVICE AND MEDIUM” and filed with the China National Intellectual Property Administration on Jul. 09, 2020, the contents of which are incorporated into this application by reference in its entity.

### TECHNICAL FIELD

The embodiments of the present disclosure relate to the field of computer technologies and, in particular, to an interacting method and apparatus, an electronic device, and a storage medium.

### BACKGROUND

An online document is often used by a user to record work or write a document, then it is shared to others for viewing, and the others may add comments to the content in the online document.

At present, comments to target content in an online document are added with a mobile terminal (e.g., a cell phone) commonly in such a way: the target content to be commented on needs to be selected first; and when the user triggers a selection operation, the system pops up a “Comment” button in the form of a bubble; then the user triggers display of a comment window by clicking on the “Comment” button; and after that, the user inputs, in the comment window, the content he/she wants to comment on.

It can be seen that the above commonly used commenting approach is not easy to operate, the process is cumbersome, and there is a problem of low commenting efficiency.

### SUMMARY

Embodiments of the present disclosure provide an interacting method and apparatus, an electronic device and a storage medium, which simplify the interacting operation and improve the interacting efficiency.

In a first aspect, an embodiment of the present disclosure provides an interacting method, including:
in response to a triggering instruction in a first direction for first content on a page, displaying the triggered first content and a triggered first triggering control;
triggering a first interacting operation on the first content based on a position of the first triggering control in a corresponding region of the first content.

In a second aspect, an embodiment of the present disclosure provides an interacting apparatus, including:
a displaying module, configured to, in response to a triggering instruction in a first direction for first content on a page, display the triggered first content and a triggered first triggering control;
a triggering module, configured to trigger a first interacting operation on the first content based on a position of the first triggering control in a corresponding region of the first content.

In a third aspect, an embodiment of the present disclosure further provides a device, including:
one or more processors;
a storage apparatus, configured to store one or more programs,
where when the one or more programs are executed by the one or more processors, the one or more processors implement the interacting method according to any one of the embodiments of the present disclosure.

In a fourth aspect, an embodiment of the present disclosure further provides a storage medium containing a computer-executable instruction, where the computer-executable instruction, when executed by a computer processor, is used to implement the interacting method according to any one of the embodiments of the present disclosure.

In a fifth aspect, an embodiment of the present disclosure further provides a computer program product including a computer program instruction, where the computer program instruction enables a computer to execute the interacting method according to any one of the embodiments of the present disclosure.

In a sixth aspect, an embodiment of the present disclosure further provides a computer program, where when the computer program is running on a computer, the computer executes the interacting method according to any one of the embodiments of the present disclosure.

According to the interacting method provided in the embodiment of the present disclosure, the interacting operation is simplified and the interacting efficiency is improved through technical means of: in response to a triggering instruction in a first direction for first content on a page, displaying the triggered first content and a triggered first triggering control; and triggering a first interacting operation on the first content based on a position of the first triggering control in a corresponding region of the first content.

### BRIEF DESCRIPTION OF DRAWINGS

The above and other features, advantages and aspects of various embodiments of the present disclosure will become more apparent when taken in conjunction with the accompanying drawings and with reference to the following description of embodiments. Throughout the drawings, same or similar reference numbers refer to the same or similar elements. It should be understood that the drawings are schematic and that components and elements are not necessarily drawn to scale.

FIG. 1 is a schematic flowchart of an interacting method according to a first embodiment of the present disclosure.

FIG. 2 is a schematic flowchart of an interacting method according to a second embodiment of the present disclosure.

FIG. 3 is a schematic diagram of a displaying state of first content and the first triggering control during an interacting operation on the first content being triggered according to the second embodiment of the present disclosure.

FIG. 4 is a schematic flowchart of an interacting method according to a third embodiment of the present disclosure.

FIG. 5 is a schematic diagram of a displaying interface when a comment function for the first content has been triggered according to the third embodiment of the present disclosure.

FIG. 6 is a schematic structural diagram of an interacting apparatus according to a fourth embodiment of the present disclosure.

FIG. 7 is a schematic structural diagram of an electronic device according to a fifth embodiment of the present disclosure.

### DESCRIPTION OF EMBODIMENTS

Embodiments of the present disclosure will be described in more detail below with reference to the accompanying drawings. Although certain embodiments of the present disclosure are illustrated in the accompanying drawings, it should be understood that the present disclosure may be implemented in various forms and should not be construed as being limited to the embodiments set forth herein. Instead, the embodiments are provided for the purpose of a more thorough and complete understanding of the present disclosure. It should be understood that the accompanying drawings and embodiments of the present disclosure are only for exemplary purposes, and are not intended to limit the protection scope of the present disclosure.

It should be understood that the various steps described in the method embodiments of the present disclosure may be performed in different orders, and/or performed in parallel. Furthermore, the method embodiments may include additional steps and/or omit execution of the illustrated steps. The scope of the present disclosure is not limited in this regard.

As used herein, the term “including” and variations thereof refer to open inclusions, i.e., “including but not limited to”. The term “based on” refers to “based at least in part on”. The term “an embodiment” represents “at least one embodiment”; the term “another embodiment” represents “at least one additional embodiment”; the term “some embodiments” represents “at least some embodiments”. Relevant definitions of other terms will be given in the description below.

It should be noted that concepts “first”, “second”, etc., mentioned in the present disclosure are only used to distinguish between different apparatuses, modules or units, and are not intended to define the order or interdependence of the functions performed by these apparatuses, modules or units.

To be noted, the singular or plural modification mentioned in the present disclosure is schematic and non-limiting, which understandably should be interpreted as “one or more” by those skilled in the art, unless the context clearly indicates otherwise.

### Embodiment 1

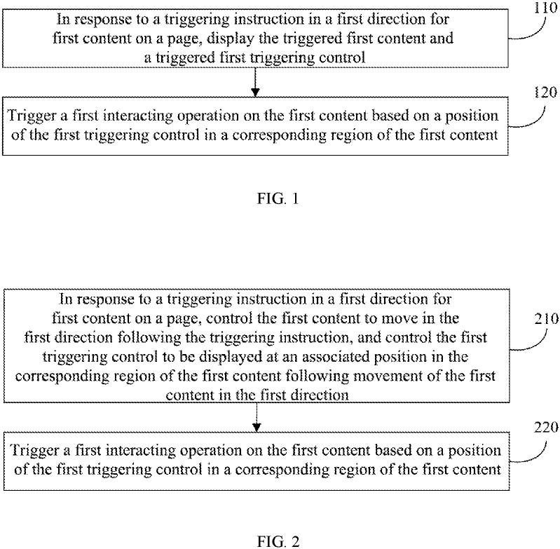

FIG. 1 is a schematic flowchart of an interacting method according to a first embodiment of the present disclosure. The method is applied to a mobile terminal with a touch display screen, such as a cell phone, and is applicable to a scenario in which interaction with target content of an online document is performed. The method may be performed by an interacting apparatus which may be implemented in a form of software and/or hardware.

As shown in FIG. 1, the interacting method according to the embodiment of the present disclosure includes the following steps.

Step 110, in response to a triggering instruction in a first direction for first content on a page, display the triggered first content and a triggered first triggering control.

The first direction may be rightward, leftward, upward or downward, etc., and the triggering instruction may specifically be an instruction to swipe a displaying page screen. For example, if a swipe operation for first content on a displaying page is performed in a first direction on a displaying screen by a user, the system will respond to the swipe operation when detecting the swipe operation, specifically, the system may change the displaying effect of the first content and display an associated first triggering control. The changing the displaying effect of the first content may be specifically to swipe the first content in the same direction as the swipe operation following the user’s swipe operation, or to swipe the first content in the opposite direction to the swipe operation following the user’s swipe operation. The first triggering control may be a control configured to prompt a target function triggered by the swipe operation.

Preferably, in a service system, the first direction may be set to be rightward in consideration of habituation and comfort of the user’s operation. That is, when it is detected that the user performs a touch swipe rightwards for a region where the first content is located on a current displaying page, the triggered first content and a triggered first triggering control are displayed.

Step 120, trigger a first interacting operation on the first content based on a position of the first triggering control in a corresponding region of the first content.

Specifically, when the triggering instruction is detected, display the first triggering control at a set position on the page; during duration of the triggering instruction, control the first triggering control to change at a displaying position on the page; and when the first triggering control reaches a preset target position, trigger a first interacting operation on the first content. In this process, the user does not need to trigger the first triggering control, the first triggering control is configured to prompt the user of a type of the first interacting operation which is currently triggered by it, and based on the position of the first triggering control in a corresponding region of the first content, the first interacting operation on the first content is automatically triggered, thereby simplifying the process of triggering the first interacting operation, so that the triggering is possible with simply a one-step operation from the user.

The first interacting operation includes any one of: commenting, deleting, inserting or setting.

Further, it is possible that the corresponding region of the first content is determined based on a position of a displaying component corresponding to the first content on the page.

According to the interacting method provided in the embodiment of the present disclosure, the interacting operation is simplified and the interacting efficiency is improved through technical means of: in response to a triggering instruction in a first direction for first content on a page, displaying the triggered first content and a triggered first triggering control; and triggering a first interacting operation on the first content based on a position of the first triggering control in a corresponding region of the first content.

### Embodiment 2

FIG. 2 is a schematic flowchart of an interacting method according to a second embodiment of the present disclosure. On the basis of the above embodiment, the scheme is further optimized in this embodiment of the present disclosure, specifically the operation of “displaying the triggered first content” is optimized, so that the first content moves in the first direction following the triggering instruction, and the first triggering control is controlled to be displayed at an associated position in the corresponding region of the first content following movement of the first content in the first direction. Such optimization is advantageous in improving the user experience and increasing the stickiness of the user to the product, thereby achieving the purpose of enhancing the product benefits. The explanation of terms identical or corresponding to those in the above embodiment will not be repeated in the present embodiment.

Step 210, in response to a triggering instruction in a first direction for first content on a page, control the first content to move in the first direction following the triggering instruction, and control the first triggering control to be displayed at an associated position in the corresponding region of the first content following movement of the first content in the first direction.

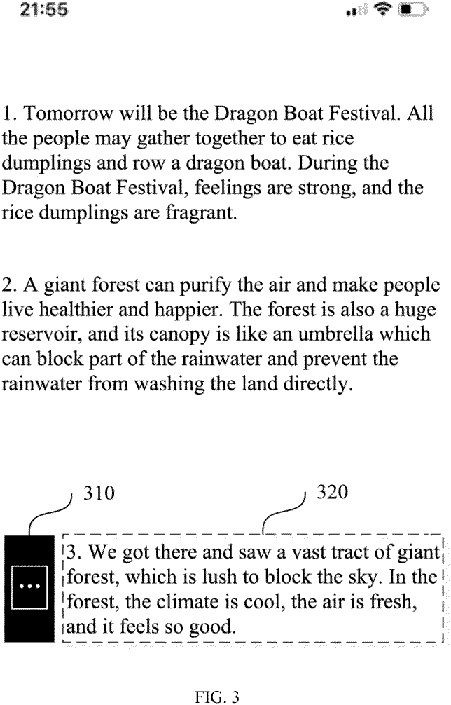

For example, in a case where the triggering instruction is specifically a swipe instruction, when the user performs a touch swipe for the first content on the page along the first direction, the first content is controlled to move in the first direction following the user’s swipe operation, and the first triggering control is controlled to be displayed at an associated position in the corresponding region of the first content following movement of the first content in the first direction. The associated position may be a position vacated when the first content is moved following the user’s swipe operation. For example, FIG. 3 illustrates a schematic diagram of a displaying state of the first content and the first triggering control during an interacting operation on the first content being triggered. As shown in FIG. 3, the first content 320 is moved rightwards by a certain distance following a swipe-to-right operation triggered by the user, the first triggering control 310 is simultaneously displayed at the associated position in the corresponding region of the first content 320, displayed specifically in the row where the first content 320 is located. The first triggering control 310 is used to prompt the user that it is currently triggering a specific interacting operation on the first content, such as a commenting operation, a deleting operation, etc. Definitely, the associated position may also be a position above or below the region where the first content is located, or any position close to the region where the first content is located.

Illustratively, the controlling the first triggering control to be displayed at the associated position in the corresponding region of the first content following movement of the first content in the first direction includes:
determining a first distance at which a swipe in the first direction on the page is performed for the triggering instruction;
determining, based on the first distance, a second distance by setting a damping function;
controlling the first content and the first triggering control to move in the first direction according to the second distance.

Further, the determining the first distance at which the swipe in the first direction on the page is performed for the triggering instruction includes:
recording an initial touching position of a finger touching the current displaying page when a first instruction for a user to touch the current display page is received;
monitoring a target touching position of the finger at the end of the current touch swipe when a second instruction for the user to perform a touch swipe in the first direction for the first content on the current displaying page is received;
determining, according to the target touching position and the initial touching position, the first distance at which the swipe in the first direction on the page is performed.

The above implementation scheme assumes to determine the first distance when the user performs, with a finger, the touch-swipe for the first content on the current displaying page. When the user performs the touch-swipe with multiple fingers, it is necessary to add up distances at which the touch-swipe is performed by the fingers, to obtain the first distance. For example, the first distance will be 5+6=11 pixels if the user first swipes in the first direction by 5 pixels with the first finger, and then continues to swipe in the first direction by 6 pixels with the second finger, after that, all fingers leave the touch screen.

Further, the controlling the first content and the first triggering control to move in the first direction according to the second distance includes:
if the second distance is less than a distance threshold, controlling the first content and the first triggering control to move in the first direction by the second distance;
if the second distance is greater than a distance threshold, controlling the first content and the first triggering control to move in the first direction by the distance threshold.

The first content cannot be moved limitlessly following the swiping of the finger(s) in order to ensure that the first content is displayed on the displaying screen with a good effect. The good effect means, for example, a reasonable font size, a reasonable line spacing, etc. When the second distance is greater than a distance threshold, the first content is controlled to move in the first direction by the distance threshold and not to move following the continuous swiping of the finger(s) any longer.

The above technical implementation of determining the first distance and the second distance is specified as follows:

when the user touches the current displaying page with his/her finger(s), that is, at touchstart, record the initial touching position(s) for touching the screen. Taking into account that there may be a case where more than one finger touches the screen, it is necessary to separately record initial touching position information of each finger touching the screen, return an ID of each finger as a key value (key) through an event, and the initial touching position of the finger corresponding to the ID is a value. Store the value in the form of a key-value, and store a total swiping distance value B of all fingers that touch the screen, and the total value B is 0 at touchstart. When the first finger performs the touch-swipe (touchmove), determine whether the swiping direction of the finger is rightward through the finger’s swiping distance from top to bottom and from left to right. If the swiping direction of the finger is rightward, enter a swipe-to-comment state and add an icon (for example, a comment icon 310 shown in FIG. 3) with a comment (here, using an example where the interacting operation is in the type of “commenting”, i.e., triggering a commenting operation on the first content) background to the left of the target region; if the swiping direction of the finger is not rightward, ignore the touching event at this time. After entering the swipe-to-comment state, obtain the swiping distance of the current finger by subtracting the initial touching position information of the event saved at touchstart from the position information to which the current finger swipes; after a touchend event is triggered, add the swiping distance of the current finger to the previously saved total swiping distance value B of all fingers, and delete the event information corresponding to the current finger. The swiping distances of other fingers may also be obtained in the above way, and finally sum up the swiping distances of all fingers. Based on the summation result (i.e. the value B), calculate, through a damping function, the distance by which the content in the target region needs to be actually moved. Finally determine whether there is still a finger on the screen. If yes, repeat the above operation; if not, delete the comment icon and bounce the content in the target region back to the initial position, then clear the stored key-value events, and reset the total distance B to 0.

Step 220, trigger a first interacting operation on the first content based on a position of the first triggering control in a corresponding region of the first content.

According to the technical solution in the embodiment of the present disclosure, the purpose of enhancing the product benefits is achieved due to the improvement of the user experience and the increase of the stickiness of the user to the product through technical means of: in response to a triggering instruction in a first direction for first content on a page, enabling the first content to move in the first direction following the triggering instruction, and controlling the first triggering control to be displayed at an associated position in the corresponding region of the first content following movement of the first content in the first direction.

### Embodiment 3

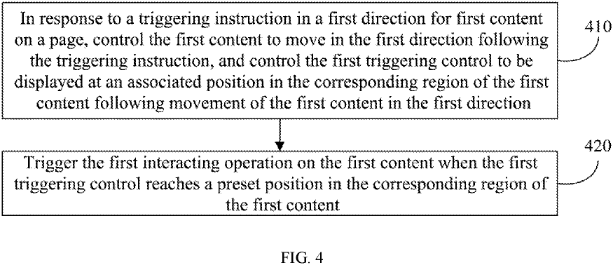

FIG. 4 is a schematic flowchart of an interacting method according to a third embodiment of the present disclosure. On the basis of the above embodiment, the scheme is further optimized in this embodiment of the present disclosure, specifically “triggering a first interacting operation on the first content based on a position of the first triggering control in a corresponding region of the first content” is optimized. When the first triggering control reaches a preset position in the corresponding region of the first content, the first interacting operation on the first content is triggered, without requiring the user to trigger the interacting operation on the first content by triggering the first triggering control, which simplifies the interacting process and improves the interacting efficiency. The explanation of terms identical or corresponding to those in the above embodiment will not be repeated in the embodiment.

As shown in FIG. 4, the method includes:

Step 410, in response to a triggering instruction in a first direction for first content on a page, control the first content to move in the first direction following the triggering instruction, and control the first triggering control to be displayed at an associated position in the corresponding region of the first content following movement of the first content in the first direction.

Step 420, trigger the first interacting operation on the first content when the first triggering control reaches a preset position in the corresponding region of the first content.

Specifically, when the first triggering control reaches a preset position in the corresponding region of the first content, a set background color is added to the first content and a text input window is displayed to enable a user to input, through the text input window, a comment message about the first content.

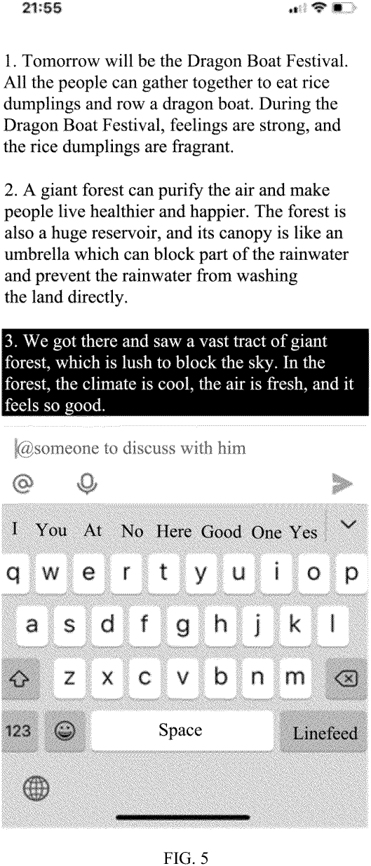

Correspondingly, reference may be made to FIG. 5, which is a schematic diagram of a displaying interface when a comment function for the first content has been triggered. In the drawing, a set background color is added to the first content, and a text input window is displayed below the first content, and the user may input, through the text input window, a comment message about the first content.

It should be noted that, the method further includes:

controlling the first content to bounce back to an initial displaying position and deleting the first triggering control displayed, when it is monitored that the triggering instruction in the first direction for the first content on the page disappears. In conjunction with FIG. 5, it can be seen that when the first interacting operation on the first content is triggered, the first content has been displayed at its initial displaying position and the first triggering control which has been deleted is no longer displayed on the page. As can be seen from FIG. 3, the first triggering control 310 is displayed on the page before the first interacting operation is triggered, and also the first content 320 experiences a positional movement during triggering of the first interacting operation. When the first interacting operation is triggered, the first content is controlled to bounce back to its initial displaying position so as to enhance the displaying effect of the first content and improve the user experience.

According to the technical solution in the present embodiment, when it is detected that the first triggering control reaches a preset position in the corresponding region of the first content, the first interacting operation on the first content is triggered, without requiring the user to trigger the interacting operation on the first content by triggering the first triggering control, which simplifies the interacting process and improves the interacting efficiency.

### Embodiment 4

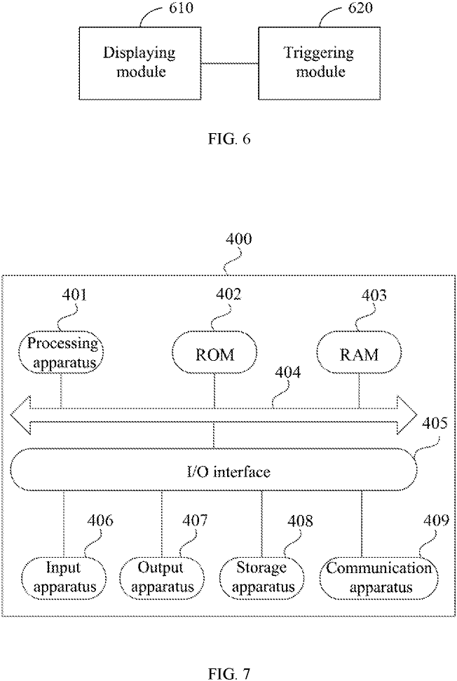

FIG. 6 shows an interacting apparatus according to a fourth embodiment of the present disclosure. The apparatus includes: a displaying module 610 and a triggering module 620.

The displaying module 610 is configured to, in response to a triggering instruction in a first direction for first content on a page, display the triggered first content and a triggered first triggering control; and the triggering module 620 is configured to trigger a first interacting operation on the first content based on a position of the first triggering control in a corresponding region of the first content.

On the basis of the above technical solution, the displaying module 610 includes a first control unit configured to control the first content to move in the first direction following the triggering instruction.

On the basis of the above technical solution, the displaying module 610 further includes a second control unit configured to control the first triggering control to be displayed at an associated position in the corresponding region of the first content following movement of the first content in the first direction.

On the basis of the above technical solution, the second control unit specifically includes:
a first determining subunit, configured to determine a first distance at which a swipe in the first direction on the page is performed for the triggering instruction;
a second determining subunit, configured to determine, based on the first distance, a second distance by setting a damping function;
a control subunit, configured to control the first content and the first triggering control to move in the first direction according to the second distance.

On the basis of each of the above technical solutions, the control subunit is specifically configured to: if the second distance is less than a distance threshold, control the first content and the first triggering control to move in the first direction by the second distance; if the second distance is greater than a distance threshold, control the first content and the first triggering control to move in the first direction by the distance threshold.

On the basis of each of the above technical solutions, the triggering module 620 includes:
a triggering unit, configured to trigger a first interaction operation on the first content when the first triggering control reaches a preset position in the corresponding region of the first content;
a control unit, configured to control the first content to bounce back to an initial displaying position, and delete the first triggering control displayed.

On the basis of each of the above technical solutions, the triggering unit is specifically configured to add a set background color to the first content and display a text input window to enable a user to input, through the text input window, a comment message about the first content.

On the basis of each of the above technical solutions, the first interacting operation includes any one of: commenting, deleting, inserting or setting.

On the basis of each of the above technical solutions, the apparatus further includes:

a determining module, configured to determine the corresponding region of the first content based on a position of a displaying component corresponding to the first content on the page.

According to the technical solution in the embodiment of the present disclosure, the interacting operation is simplified and the interacting efficiency is improved through technical means of: in response to a triggering instruction in a first direction for first content on a page, displaying the triggered first content and a triggered first triggering control; and triggering a first interacting operation on the first content based on a position of the first triggering control in a corresponding region of the first content.

The interacting apparatus according to the embodiment of the present disclosure can execute the interacting method according to any embodiment of the present disclosure, and has corresponding functional modules and beneficial effects for execution of the method.

It is worth noting that, the units and modules included in the above apparatus are only divided according to the functional logic, but are not limited to the above division, as long as they can achieve the corresponding functions. In addition, the specific names of the functional units are only for the convenience of distinguishing from each other, and are not used to limit the scope of protection scope of the embodiments of the present disclosure.

### Embodiment 5

Reference is made hereunder to FIG. 7, which shows a schematic structural diagram of an electronic device (e.g., a terminal device or a server in FIG. 7) 400 suitable for implementing the embodiments of the present disclosure. The terminal device in the embodiment of the present disclosure may include, but not limited to, a mobile device, such as a mobile phone, a notebook computer, a digital broadcast receiver, a PDA (personal digital assistant, personal digital assistant), a PAD (tablet computer, portable android device), a PMP (portable multimedia player, personal multimedia player), a vehicle-mounted terminal (e.g., a vehicle-mounted navigation terminal), etc.; and a fixed terminal such as a digital TV (television, television), a desktop computer, etc. The electronic device shown in FIG. 7 is only an example, and should not bring any limitation to the function and scope of use for the embodiments of the present disclosure.

As shown in FIG. 7, the electronic device 400 may include a processing apparatus (such as a central processing unit, a graphics processor, etc.) 401, which may execute various suitable actions and processing according to programs stored in a read-only memory (read only memory, ROM) 402 or programs loaded into a random access memory (random access memory, RAM) 403 from a storage apparatus 406. In the RAM 403, various programs and data required for the operation of the electronic device 400 are also stored. The processing apparatus 401, the ROM 402, and the RAM 403 are connected to each other through a bus 404. An input/output (input/output, I/O) interface 405 is also connected to the bus 404.

Generally, the following devices can be connected to the I/O interface 405: an input apparatus 406, including for example a touch screen, a touch pad, a keyboard, a mouse, a camera, a microphone, an accelerometer, a gyroscope, etc.; an output apparatus 407, including for example a liquid crystal display (liquid crystal display, LCD), a speaker, a vibrator, etc.; and a storage apparatus 406, including for example a magnetic tape, a hard disk, etc.; and a communication apparatus 409. The communication apparatus 409 may allow the electronic device 400 to perform wireless or wired communication with other devices to exchange data. Although FIG. 7 shows the electronic device 400 with multiple kinds of apparatuses, it is not required to implement or have all the apparatuses shown. Alternatively, more or fewer apparatuses may be implemented or provided.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, and the computer program contains program codes for executing the method shown in the flowchart. In such an embodiment, the computer program may be downloaded and installed from the network through the communication device 409, or installed from the storage apparatus 406, or installed from the ROM 402. When the computer program is executed by the processing apparatus 401, the above-mentioned functions defined in the method of the embodiment of the present disclosure are executed.

The terminal according to the embodiment of the present disclosure and the interacting method according to the above embodiments belong to the same inventive concept. For technical details that are not described in detail in the embodiment of the present disclosure, reference may be made to the above embodiments; and the embodiment of the present disclosure has the same beneficial effect as the above embodiments.

### Embodiment 6

An embodiment of the present disclosure provides a computer storage medium with a computer program stored thereon. When the program is executed by a processor, the interacting method according to the above embodiments is implemented.

### Embodiment 7

An embodiment of the present disclosure provides a computer program which, when running on a computer, enables the computer to execute the interacting method according to the above embodiments.

### Embodiment 8

An embodiment of the present disclosure provides a computer program product including a computer program instruction, where the computer program instruction enables a computer to execute the interacting method according to the above embodiments.

It should be noted that the above-mentioned computer-readable medium in the present disclosure may be a computer-readable signal medium or a computer-readable storage medium, or any combination thereof. The computer-readable storage medium may be, for example, but not limited to, an electrical, a magnetic, an optical, an electromagnetic, an infrared, or a semiconductor system, apparatus, or device, or any combination thereof. More specific examples of the computer-readable storage medium may include, but are not limited to, an electrically connected portable computer disk with one or more wires, a hard disk, a random access memory (random access memory, RAM), read-only memory (read-only memory, ROM), an erasable programmable read-only memory (electrical programmable ROM, EPROM or flash memory), an optical fiber, a portable compact disc ROM (compact disc ROM, CD-ROM), an optical storage device, a magnetic memory device, or any suitable combination of the above. In the present disclosure, the computer-readable storage medium may be any tangible medium that includes or stores a program, and the program may be used by or in combination with an instruction execution system, apparatus, or device. In the present disclosure, the computer-readable signal medium may include a data signal propagated in a baseband or as a part of a carrier wave, and computer-readable program codes are carried therein. This propagated data signal can take many forms, including but not limited to electromagnetic signal, optical signal, or any suitable combination thereof. The computer-readable signal medium may also be any computer-readable medium other than the computer-readable storage medium. The computer-readable signal medium may send, propagate, or transmit the program used by or in combination with the instruction execution system, apparatus, or device. The program codes contained on the computer-readable medium may be transmitted by any suitable medium, including but not limited to: a wire, an optical cable, an RF (radio frequency, radio frequency), etc., or any suitable combination of the above.

In some embodiments, a client and a server can use any currently known or future developed network protocol, such as HTTP (HyperText Transfer Protocol, hypertext transfer protocol), to communicate, and can be interconneted with digital data communication (eg, communication network) in any form or medium. Examples of the communication network include a local area network (local area network, “LAN”), a wide area network (wide area network, “WAN”), the Internet work (e.g., the Internet), and a peer-to-peer network (e.g., an ad hoc peer-to-peer network), and any currently known or future developed network.

The above-mentioned computer-readable medium may be included in the above-mentioned electronic device; or it may exist alone without being assembled into the electronic device.

The above computer-readable medium carries one or more programs. When the foregoing one or more programs are executed by the electronic device, the electronic device is enabled to:
in response to a triggering instruction in a first direction for first content on a page, display the triggered first content and a triggered first triggering control;
trigger a first interacting operation on the first content based on a position of the first triggering control in a corresponding region of the first content.

The computer program codes that are used to perform operations of the present disclosure may be written in one or more programming languages or a combination thereof. The above-mentioned programming languages include, but not limited to, an object-oriented programming language — such as Java, Smalltalk, C++, and also include a conventional procedural programming language — such as “C” language or similar programming language. The program codes may be executed entirely on a computer of a user, partly on a computer of a user, executed as an independent software package, partly executed on a computer of a user and partly executed on a remote computer, or entirely executed on a remote computer or server. In a case where a remote computer is involved, the remote computer may be connected to the computer of the user through any kind of network — including a local area network (LAN) or a wide area network (WAN), or, it may be connected to an external computer (for example, connected via the Internet through an Internet service provider).

The flowcharts and block diagrams in the accompanying drawings illustrate possible implementation architecture, functions, and operations of the system, method, and computer program product according to the embodiments of the present disclosure. In this point, each block in the flowchart or block diagram may represent a module, a program segment, or a part of codes, and the module, the program segment, or the part of codes contains one or more executable instructions for implementing a designated logical function. It should also be noted that, in some alternative implementations, the functions marked in the blocks may also occur in a different order from the order marked in the drawings. For example, two blocks shown one after another may actually be executed substantially in parallel, or sometimes may be executed in a reverse order, which depends on the functions involved. It should also be noted that each block in the block diagram and/or flowchart, and the combination of the blocks in the block diagram and/or flowchart, can be implemented by a dedicated hardware-based system that performs the specified functions or operations, or implemented by a combination of dedicated hardware and computer instructions.

The units involved in the embodiments described in the present disclosure may be implemented in software or hardware. The name of a unit does not constitute a limitation on the unit itself in a certain case. For example, an editable content displaying unit may also be described as an “editing unit”.

The functions described herein above may be performed at least in part by one or more hardware logic components. For example, non-restrictively, exemplary types of hardware logic components that may be used include: a field programmable gate array (field programmable gate array, FPGA), an application specific integrated circuit (application specific integrated circuit, ASIC), an application specific standard product (application specific sStandard parts, ASSP), a system on chip (system on chip, SOC), a complex programmable logic device (complex programming logic device, CPLD), etc.

In the context of the present disclosure, the machine-readable medium may be a tangible medium, which may contain or store a program for use by or in combination with an instruction execution system, apparatus or device. The machine-readable medium may be a machine-readable signal medium or a machine-readable storage medium. The machine-readable medium may include, but is not limited to, an electronic, a magnetic, an optical, an electromagnetic, an infrared, or a semiconductor system, apparatus, or device, or any suitable combination thereof. More specific examples of the machine-readable storage medium may include an electrically connected portable computer disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, a first example provides an interacting method, which includes:
in response to a triggering instruction in a first direction for first content on a page, displaying the triggered first content and a triggered first triggering control;
triggering a first interacting operation on the first content based on a position of the first triggering control in a corresponding region of the first content.

According to one or more embodiments of the present disclosure, a second example provides an interacting method, optionally, the displaying the triggered first content includes:

controlling the first content to move in the first direction following the triggering instruction.

According to one or more embodiments of the present disclosure, a third example provides an interactive method, optionally, the displaying the triggered first triggering control includes:

controlling the first triggering control to be displayed at an associated position in the corresponding region of the first content following movement of the first content in the first direction.

According to one or more embodiments of the present disclosure, a fourth example provides an interactive method, optionally, the controlling the first triggering control to be displayed at the associated position in the corresponding region of the first content following movement of the first content in the first direction includes:
determining a first distance at which a swipe in the first direction on the page is performed for the triggering instruction;
determining, based on the first distance, a second distance by setting a damping function;
controlling the first content and the first triggering control to move in the first direction according to the second distance.

According to one or more embodiments of the present disclosure, a fifth example provides an interactive method, optionally, the controlling the first content and the first triggering control to move in the first direction according to the second distance includes:
if the second distance is less than a distance threshold, controlling the first content and the first triggering control to move in the first direction by the second distance;
if the second distance is greater than a distance threshold, controlling the first content and the first triggering control to move in the first direction by the distance threshold.

According to one or more embodiments of the present disclosure, a sixth example provides an interactive method, optionally, the triggering the first interacting operation on the first content based on the position of the first triggering control in the corresponding region of the first content includes:

triggering the first interacting operation on the first content when the first triggering control reaches a preset position in the corresponding region of the first content.

According to one or more embodiments of the present disclosure, a seventh example provides an interactive method, optionally, the triggering the first interacting operation on the first content based on the position of the first triggering control in the corresponding region of the first content includes:

controlling the first content to bounce back to an initial displaying position and deleting the first triggering control displayed.

According to one or more embodiments of the present disclosure, an eighth example provides an interacting method, optionally, the triggering the first interacting operation on the first content includes:

adding a set background color to the first content and displaying a text input window to enable a user to input, through the text input window, a comment message about the first content.

According to one or more embodiments of the present disclosure, a ninth example provides an interactive method, optionally, the first interacting operation includes any one of: commenting, deleting, inserting or setting.

According to one or more embodiments of the present disclosure, a tenth example provides an interacting method, optionally, the method further includes: determining the corresponding region of the first content based on a position of a displaying component corresponding to the first content on the page.

According to one or more embodiments of the present disclosure, an eleventh example provides an interacting apparatus, which includes:
a displaying module, configured to, in response to a triggering instruction in a first direction for first content on a page, display the triggered first content and a triggered first triggering control;
a triggering module, configured to trigger a first interacting operation on the first content based on a position of the first triggering control in a corresponding region of the first content.

According to one or more embodiments of the present disclosure, a twelfth example provides an electronic device, which includes:
one or more processors;
a storage apparatus, configured to store one or more programs,
where when the one or more programs are executed by the one or more processors, the one or more processors implement the interacting method including:
   in response to a triggering instruction in a first direction for first content on a page, displaying the triggered first content and a triggered first triggering control;
   triggering a first interacting operation on the first content based on a position of the first triggering control in a corresponding region of the first content.

According to one or more embodiments of the present disclosure, a thirteenth example provides a storage medium including a computer-executable instruction, where the computer-executable instruction, when executed by a computer processor, is used to execute the interacting method including:
in response to a triggering instruction in a first direction for first content on a page, displaying the triggered first content and a triggered first triggering control;
triggering a first interacting operation on the first content based on a position of the first triggering control in a corresponding region of the first content.

According to one or more embodiments of the present disclosure, a fourteenth example provides a computer program which, when running on a computer, enables the computer to execute the interacting method including:
in response to a triggering instruction in a first direction for first content on a page, displaying the triggered first content and a triggered first triggering control;
triggering a first interacting operation on the first content based on a position of the first triggering control in a corresponding region of the first content.

According to one or more embodiments of the present disclosure, a fifteenth example provides a computer program product, including a computer program instruction, where the computer program instruction enables a computer to execute the interacting method including:
in response to a triggering instruction in a first direction for first content on a page, displaying the triggered first content and a triggered first triggering control;
triggering a first interacting operation on the first content based on a position of the first triggering control in a corresponding region of the first content.

The above description is only intended for preferred embodiments of the present disclosure and explanation of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features without departing from the above disclosed concept. For example, the above-mentioned features and the technical features disclosed in the present disclosure (but not limited to) having similar functions are replaced with each other to form a technical solution.

In addition, although various operations are described in a specific order, this should not be understood as requiring these operations to be performed in the specific order or in a sequential order shown. Under certain circumstances, multitasking and parallel processing may be advantageous. Similarly, although several specific implementation details are included in the above discussion, these should not be interpreted as limiting the scope of the present disclosure. Certain features that are described in the context of separate embodiments can also be implemented in combination in a single embodiment. On the contrary, various features described in the context of a single embodiment can also be implemented in multiple embodiments individually or in any suitable subcombination.

Although the subject matter has been described in language specific to a structural feature and/or a logical action of the method, it should be understood that the subject matter defined in the appended claims is not necessarily limited to the specific features or actions described above. On the contrary, the specific features and actions described above are only exemplary forms for implementing the claims.

1. An interacting method, comprising:
in response to a triggering instruction in a first direction for first content on a page, displaying the triggered first content and a triggered first triggering control;
triggering a first interacting operation on the first content based on a position of the first triggering control in a corresponding region of the first content.

2. The method according to claim 1, wherein the displaying the triggered first content comprises:
controlling the first content to move in the first direction following the triggering instruction.

3. The method according to claim 2, wherein the displaying the triggered first triggering control comprises:
controlling the first triggering control to be displayed at an associated position in the corresponding region of the first content following movement of the first content in the first direction.

4. The method according to claim 3, wherein the controlling the first triggering control to be displayed at the associated position in the corresponding region of the first content following movement of the first content in the first direction comprises:
determining a first distance at which a swipe in the first direction on the page is performed for the triggering instruction;
determining, based on the first distance, a second distance by setting a damping function;
controlling the first content and the first triggering control to move in the first direction according to the second distance.

5. The method according to claim 4, wherein the controlling the first content and the first triggering control to move in the first direction according to the second distance comprises:
if the second distance is less than a distance threshold, controlling the first content and the first triggering control to move in the first direction by the second distance;
if the second distance is greater than a distance threshold, controlling the first content and the first triggering control to move in the first direction by the distance threshold.

6. The method according to claim 3, wherein the triggering the first interacting operation on the first content based on the position of the first triggering control in the corresponding region of the first content comprises:
triggering the first interacting operation on the first content when the first triggering control reaches a preset position in the corresponding region of the first content.

7. The method according to claim 3, wherein the triggering the first interacting operation on the first content based on the position of the first triggering control in the corresponding region of the first content comprises:
controlling the first content to bounce back to an initial displaying position and deleting the first triggering control displayed.

8. The method according to claim 1, wherein the triggering the first interacting operation on the first content comprises:
adding a set background color to the first content and displaying a text input window to enable a user to input, through the text input window, a comment message about the first content.

9. The method according to claim 1, wherein the first interacting operation comprises any one of: commenting, deleting, inserting or setting.

10. The method according to claim 1, further comprising:
determining the corresponding region of the first content based on a position of a displaying component corresponding to the first content on the page.

11. An interacting apparatus, comprising:
at least one processor; and
a memory communicatively connected to the at least one processor; wherein,
the memory stores instructions executable by the at least one processor, and the instructions are executed by the at least one processor, so that the at least one processor is configured to:
in response to a triggering instruction in a first direction for first content on a page, display the triggered first content and a triggered first triggering control;
trigger a first interacting operation on the first content based on a position of the first triggering control in a corresponding region of the first content.

12. The interacting apparatus according to claim 11, wherein the at least one processor is configured to control the first content to move in the first direction following the triggering instruction.

13. The interacting apparatus according to claim 12, wherein the at least one processor is configured to control the first triggering control to be displayed at an associated position in the corresponding region of the first content following movement of the first content in the first direction.

14. The interacting apparatus according to claim 13, wherein the at least one processor is configured to:
determine a first distance at which a swipe in the first direction on the page is performed for the triggering instruction;
determine, based on the first distance, a second distance by setting a damping function;
control the first content and the first triggering control to move in the first direction according to the second distance.

15. The interacting apparatus according to claim 14, wherein the at least one processor is configured to:
if the second distance is less than a distance threshold, control the first content and the first triggering control to move in the first direction by the second distance;
if the second distance is greater than a distance threshold, control the first content and the first triggering control to move in the first direction by the distance threshold.

16. The interacting apparatus according to claim 13, wherein the at least one processor is configured to:
trigger a first interaction operation on the first content when the first triggering control reaches a preset position in the corresponding region of the first content.

17. The interacting apparatus according to claim 13, wherein the at least one processor is configured to :
control the first content to bounce back to an initial displaying position, and delete the first triggering control displayed.

18. The interacting apparatus according to claim 11, wherein the at least one processor is configured to add a set background color to the first content and display a text input window to enable a user to input, through the text input window, a comment message about the first content.

19. The interacting apparatus according to claim 11, wherein the first interacting operation comprises any one of: commenting, deleting, inserting or setting.

20. (canceled)

21. (canceled)

22. A non-transitory storage medium containing a computer-executable instruction, wherein the computer-executable instruction, when executed by a computer processor, is used to implement the steps of
in response to a triggering instruction in a first direction for first content on a page, displaying the triggered first content and a triggered first triggering control;
triggering a first interacting operation on the first content based on a position of the first triggering control in a corresponding region of the first content.

23. (canceled)

24. (canceled)
